(19) United States
(12) Patent Application Publication
(10) Pub. No.: US 2023/0271662 A1
(43) Pub. Date: Aug. 31, 2023

(54) Fixture used to house audio and electronic equipment for sport bikes

(71) Applicant: Malcolm O'Neil Jamison, JR., Washington, DC (US)

(72) Inventor: Malcolm O'Neil Jamison, JR., Washington, DC (US)

(21) Appl. No.: 17/681,797

(22) Filed: Feb. 27, 2022

(51) Int. Cl. B62J 45/10; H04R 1/02

(52) U.S. Cl. CPC B62J 45/10; H04R 1/02

(57) ABSTRACT

The present invention relates generally to speaker systems for motorcycles or motorcycle type vehicles. More specifically, the invention relates to a speaker assembly that is designed to provide sound or music for a sports motorcycle or sports bike and is designed to replace the air vent cover on a motorcycle. The speaker assembly has a compartment for housing a first speaker and an attachment to house a second speaker. The assembly has an elegant design and smoothly fits within the contour of the sports bike. The user simply removes the existing air vent cover and snap fits the speaker assembly to the motorcycle. The speaker assembly has a left and a right side therefore providing high quality stereo sound. By attaching the speakers to a music playback device, the bike owner has effectively converted his sports motorcycle or sports bike into a luxury sport bike.

### FIELD OF THE INVENTION

The invention relates generally to sound systems for motorcycles. More specifically, the invention relates to a speaker assembly that attaches to a sports bike thus providing high quality music to the rider while riding his or her sports bike.

### BACKGROUND OF THE INVENTION

Since the creation of the motorcycle, cycle enthusiasts have constantly looked for ways to improve the biking experience. Such innovations as wind screens, crash guards, saddle bags, special lights, foot rests and fairings, to name a few, have vastly improved the biking experience for bikers. Some of the bigger, bulker bikes have large fairings that encapsulate the front part of the bike and contain a large wind screen and usually a sound system. Most police motorcycles employ this design and many older bikers love touring great distances on these types of bikes. However, a great number of bikers prefer the sleek, fast, and powerful bikes that resemble racing bikes. Because the people who design these bikes place a premium on speed and power, they typically design them to be lite weight and as aerodynamic as possible. Consequently, sports bike manufacturers do not put audio speakers or sound systems on sports bikes because the added weight along with the reduction in aerodynamics would vastly hinder the performance of the bike and substantially hinder motorcycle purchases.

Because of this, for decades bikers have resorted to listening to music while they ride via ear pods or headphones. There is a desire in the sports biking community for the bikers to be able to play high quality music while riding their sports bike without having to resort to ear pods or headphones.

### SUMMARY OF THE INVENTION

The present invention solves the aforementioned problem of bikers not being able to listen to music while riding their sports bikes. With this invention, sports bikes can be equipped with a speaker assembly having a left and right side, providing high quality stereo sound for the rider. The assembly replaces the air vent cover and contains a plurality of high-quality speakers that attach to a music playback device installed on the sports bike. By replacing the air vent cover, the speaker assembly maintains the sleek, aerodynamic design of the sports bike while simultaneously providing quality sound. The speaker assembly snap fits onto the sports bike and can be installed by the user or a local mechanic. The speakers in the speaker assembly are attached to a music playback device. The speaker assembly of the present invention transforms the average sports bike into a luxury sports bike.

It is therefore a primary objective of the invention to provide a system that allows sports bikes to play high quality music.

It is yet another objective of the invention to provide a speaker assembly having a plurality of speakers.

It is another objective of the invention to provide a speaker assembly that replaces the air vent cover on a sports bike.

In yet another objective of the invention, the speaker assembly maintains the sleek lines and aerodynamics of the sports bike.

Furthermore, it is an object of the invention to provide a speaker assembly that snap fits onto the sports bike.

Additional objectives and embodiments of this invention will be apparent from reading the detailed description of the invention and the accompanying drawings.

### BRIEF DESCRIPTION OF THE DRAWINGS

FIG. 1 is a top view of the left side of the speaker assembly with the speakers attached showing.

FIG. 2 is an isometric view of the left side of the speaker assembly

FIG. 3 is an isometric view of the left side of the speaker assembly showing a vertical configuration.

FIG. 4 is a bottom side view of the left side of the speaker assembly.

FIG. 5 is a top view of the left side of the speaker assembly without the speakers attached.

FIG. 6 is a partial view of the top part of the left side of the speaker assembly.

FIG. 7 is an isometric view of the right side of the speaker assembly.

FIG. 8 is an isometric view of the right side of the speaker assembly.

FIG. 9 is an environmental view of left side of the speaker assembly showing the assembly attached to a motorcycle.

FIG. 10 is an environmental view of the left side of the speaker assembly showing the assembly attached to a motorcycle.

### DETAILED DESCRIPTION OF THE PREFERRED EMBODIMENTS

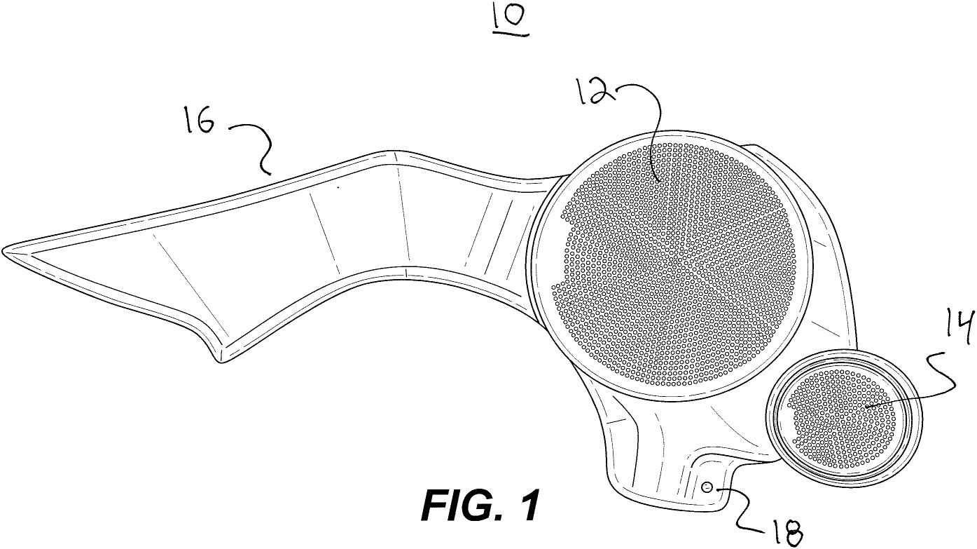

FIG. 1 illustrates a speaker assembly 10 having a left housing 16, a first audio speaker 12, a second speaker 14 and a rivet hole 18. Speaker assembly 10 replaces the air vent covers (left and right side) on a sports bike. The left housing 16 in FIG. 1 shows the left side of the speaker assembly 10. The rivet hole 18 is dimensioned and configured to receive the rivet on the motorcycle that is exposed when the air vent cover is removed. Speaker assembly 10 snaps fits onto the motorcycle via rivet hole 18. Although not shown, speakers 12, 14 are attached via speaker wires to a music playback device.

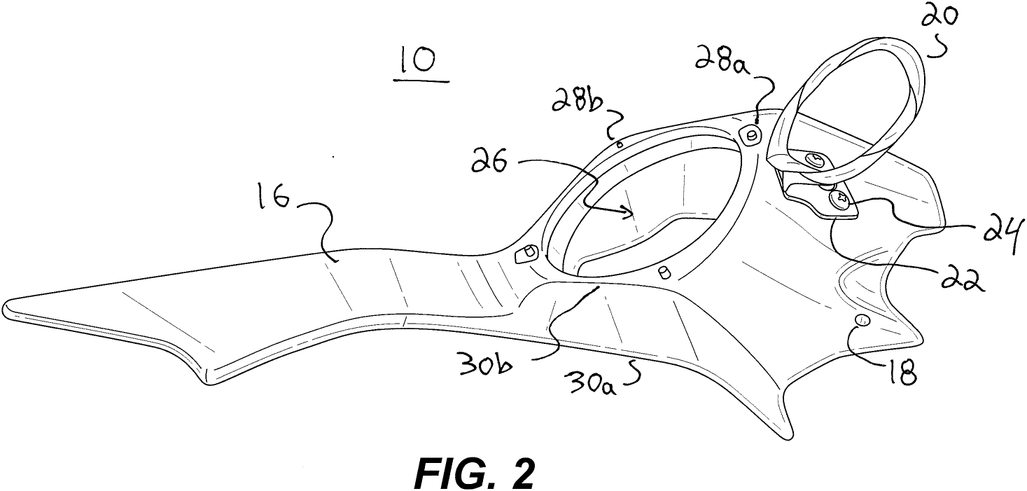

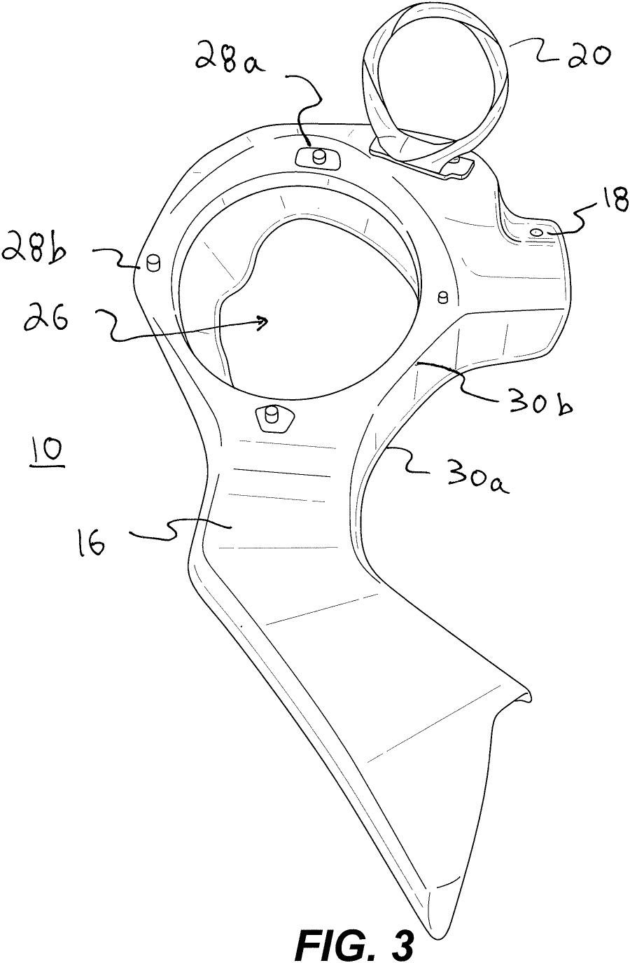

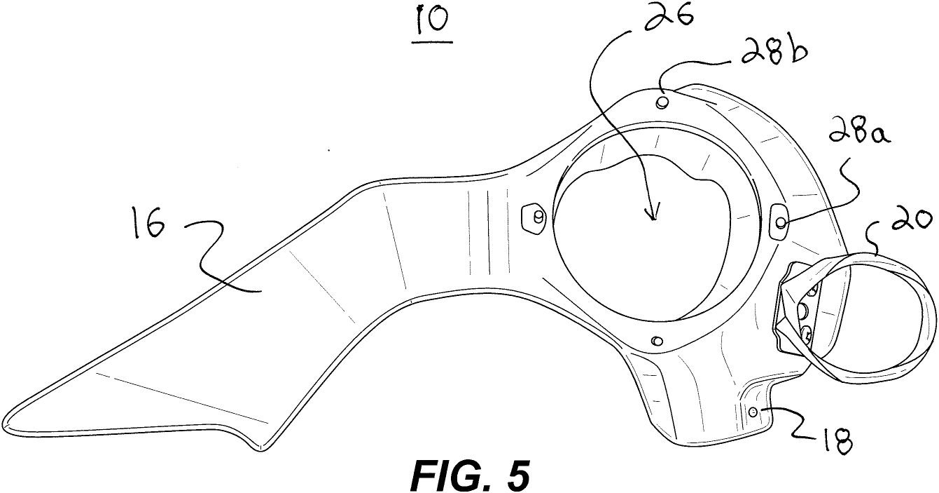

FIG. 2 and FIG. 5 show a speaker assembly 10 having a left housing 16 wherein located on the housing 16 is an opening 26 and a speaker attachment 20. The opening 26 is dimensioned and configured to receive a first audio speaker and the speaker attachment 20 is dimensioned and configured to contain a second audio speaker. Speaker attachment 20 is attached to left housing 16 via screws 24 and an attachment base 22. Located on left housing 16 are first speaker post 28a and second speaker post 28b. Speaker posts 28a & 28b are designed to secure the speaker to housing 10. The first edge 30a on housing 10 is elevated in comparison to second edge 30b. The difference in edge height is due to the left housing 16 conforming to the original shape of the air vent cover on the motorcycle. Rivet hole 18 is used to attach the housing 10 to the motorcycle via a rivet on the motorcycle. This assists in installing the housing 10 to the motorcycle. FIG. 3 shows the speaker assembly 10 looking longways at left housing 16. This view more clearly shows the device as it would be seen on the left side of the bike by the rider. The relationship between speaker attachment 20 and the opening 26 for the first audio speaker can be clearly seen. In a normal configuration, the opening 26 would contain a mid-range or bass speaker and speaker attachment 20 would contain a treble speaker. The isometric view of FIG. 2 illustrates how speaker assembly 10 is dimensioned and configured to maintain the aerodynamics of the motorcycle.

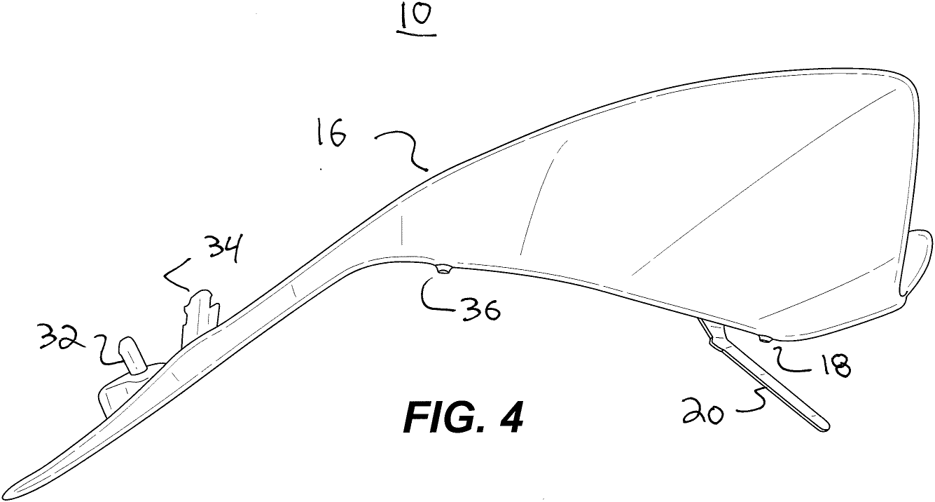

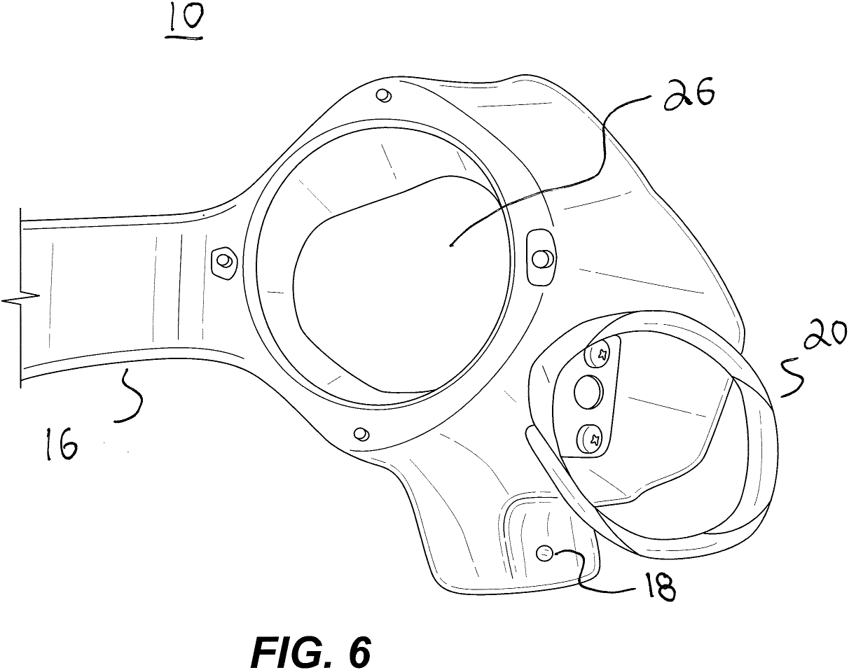

FIG. 4 shows a bottom side view of the left housing 16 of the speaker assembly 10. A first locking mechanism 32 and a second locking mechanism 34 are used to attach the housing 16 to the motorcycle. A second rivet hole 36 allows the left housing 16 to snap fit onto the motorcycle. FIG. 6 shows a partial view of the left housing 16 of speaker assembly 10 wherein the opening 26 and speaker attachment 20 are more clearly shown.

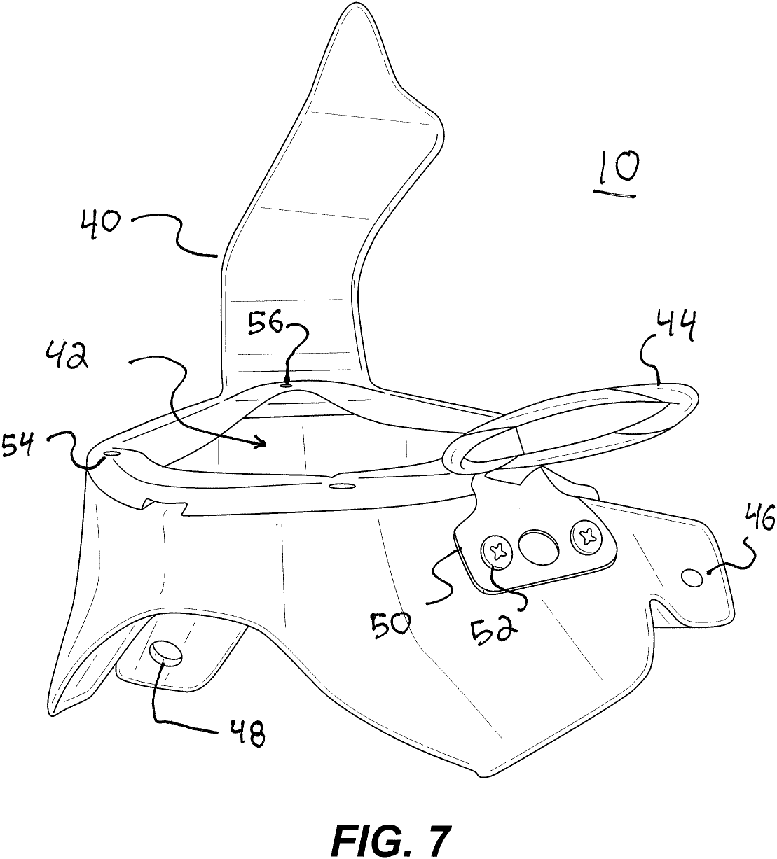

FIG. 7 illustrates the speaker assembly 10 of the present invention with a focus on the right side of the motorcycle with right housing 40. Speaker attachment 44 is secured to right housing 40 via attachment base 50 and screws 52. An opening 42 is dimensioned and configured in right housing 40 to contain a speaker. Attachments 54 and 56 are used to attach a speaker within the opening 42. A first rivet hole 46 and a second rivet hole 48 attach the right housing 40 to the motorcycle. 1

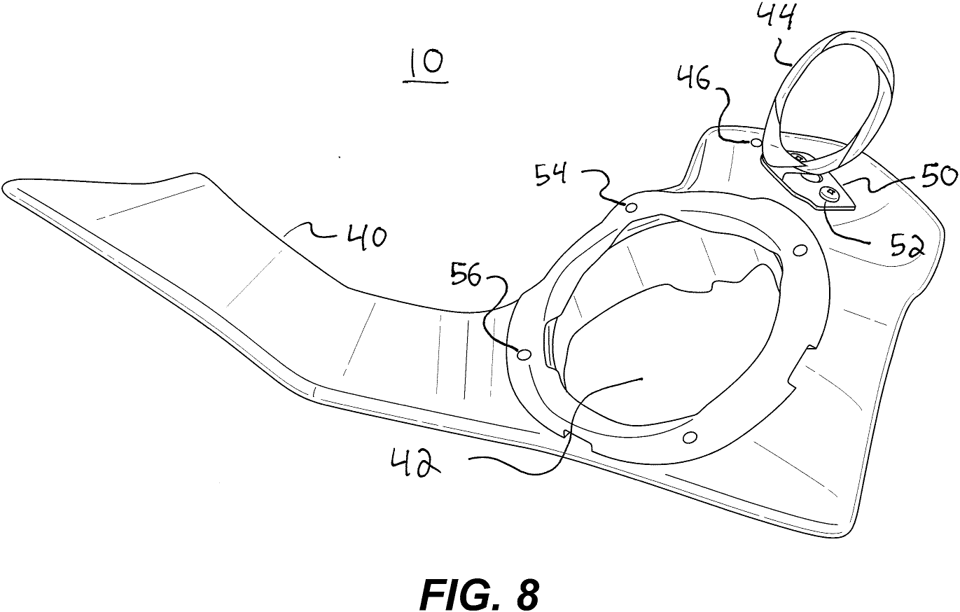

FIG. 8 shows an isometric view of right housing 40 of speaker assembly 10 and clearly illustrates the orientation of opening 42 to speaker attachment 44. First rivet hole 46 is shown adjacent to attachment base 50.

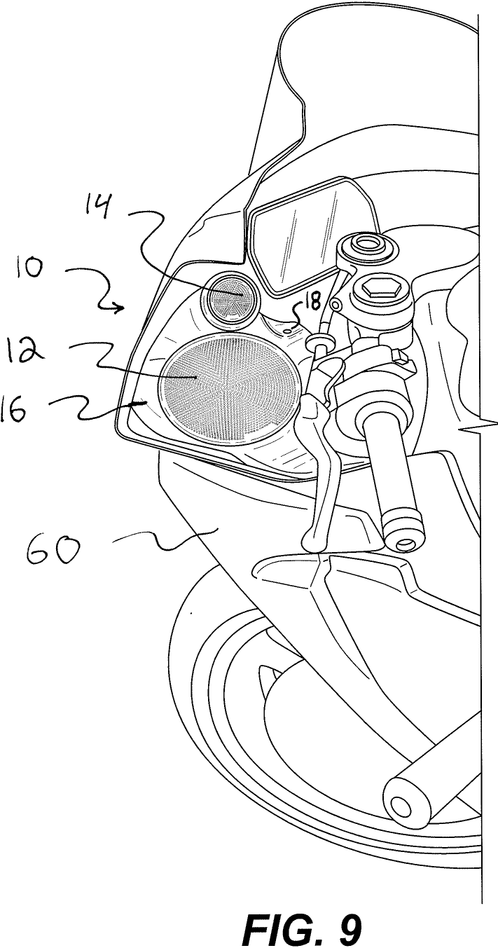

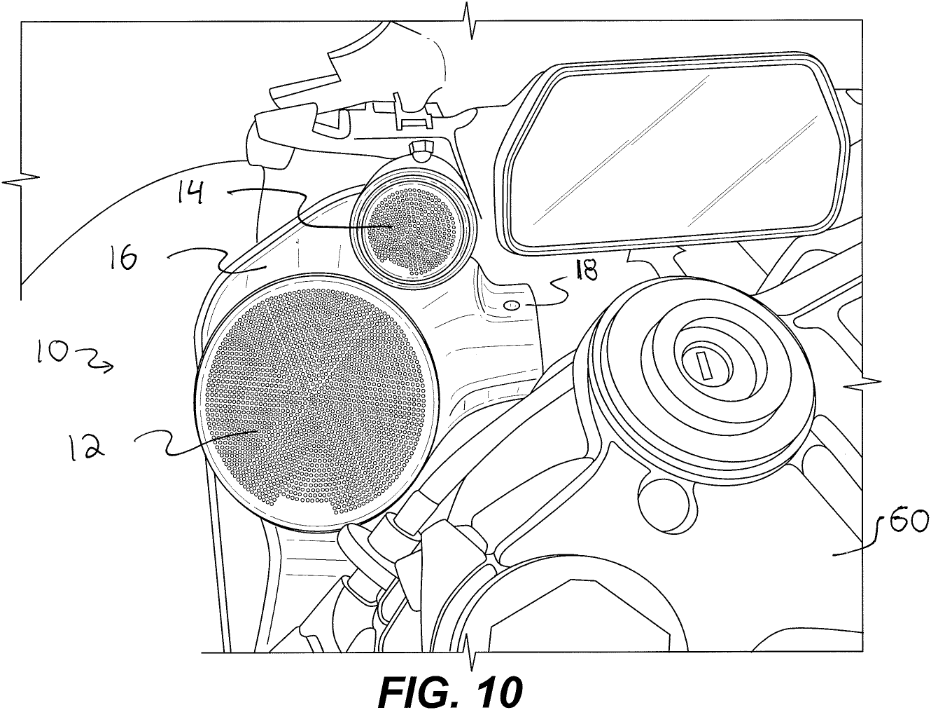

FIG. 9 shows an environmental view of the present invention wherein left housing 16 of speaker assembly 10 is shown attached to a motorcycle 60. First audio speaker 12 and second audio speaker 14 are illustrated attached to left housing 16. Left housing 16 is attached to the motorcycle via rivet hole 18. FIG. 10 is a closer environmental view of speaker assembly 10 as it is attached to motorcycle 60 via left housing 16 and rivet hole 18. First speaker 12 and second speaker 14 are attached to left housing 16. Left housing 16 is dimensioned and configured to replace the air vent cover on motorcycle 60. The design of left housing 16 maintains the aerodynamics of the motorcycle and does not contribute in any significant way to the overall wight of the motorcycle.

Additional embodiments of the present invention include but are not limited to using only a single speaker in the left or right housing or conversely, using a multitude of speakers in the left and/or the right housing. Furthermore, there are a multitude of ways to attach the left and right housings to the motorcycle beyond the attachment means disclosed herein. Other embodiments or modifications of the instant invention may become apparent upon the review of the disclosures herein and those embodiments or modifications are deemed to fall within the scope of specifications and claims.

I claim:

1. A speaker assembly for a motorcycle wherein the motorcycle has an air vent cover wherein said speaker assembly comprises a housing wherein said housing is dimensioned and figured to contain sound reinforcement means and wherein said housing has attachment means to attach said housing to the motorcycle.

2. The speaker assembly in claim 1 wherein said sound reinforcement means comprise a plurality of audio speakers.

3. The speaker assembly in claim 2 wherein said housing has a left side and a right side.

4. The speaker assembly in claim 3 wherein said left side and said right side of said housing are independently removeable from the motorcycle and wherein said housing is dimensioned and configured to replace the air vent cover of the motorcycle.

5. The speaker assembly in claim 1 wherein said sound reinforcement means comprise a first audio speaker and a second audio speaker.

6. The speaker assembly in claim 5 wherein said housing has an opening dimensioned and configured to contain said first audio speaker.

7. The speaker assembly in claim 6 further comprising speaker attachment means wherein said speaker attachment means are dimensioned and configured to contain said second speaker.

8. The speaker assembly in claim 7 wherein said speaker attachment means attach to said housing.

9. The speaker assembly in claim 8 wherein said housing dimensioned and configured to replace the air vent cover.

10. The speaker assembly in claim 9 wherein said housing is removeable.

11. The speaker assembly in claim 10 wherein said housing has a base edge and a top edge wherein said base edge is lower than said top edge.

12. The speaker assembly in claim 11 wherein said housing has a left side and wherein said housing has a right side.

13. The speaker assembly in claim 12 wherein said housing has a locking mechanism to lock said housing onto the motorcycle.

14. The speaker assembly in claim 13 wherein said left side of said housing sits on the left side of the motorcycle and wherein said right side of said housing sits on the right side of the motorcycle and wherein said left side of said housing and said right side of said housing are independently removable from the motorcycle.

15. A speaker assembly for a motorcycle comprising a housing wherein said housing is removeable from the motorcycle and wherein said housing is dimensioned and figured to contain sound reinforcement means and wherein said housing has attachment means to attach said housing to the motorcycle.

16. The speaker assembly in claim 15 wherein said sound reinforcement means comprise a first audio speaker and a second audio speaker wherein said housing has an opening and said opening is dimensioned and configured to contain said first audio speaker.

17. The speaker assembly in claim 16 further comprising speaker attachment means wherein said speaker attachment means are dimensioned and configured to contain said second audio speaker.

18. The speaker assembly in claim 17 wherein said speaker attachment means are attached to said housing and wherein said housing is dimensioned and configured to replace the air vent cover of the motorcycle.

19. A speaker assembly for a motorcycle wherein the motorcycle has an air vent cover wherein said speaker assembly comprises a first housing, a second housing, and sound reinforcement means wherein said first housing and said second housing are independently detachable from the motorcycle and wherein said first housing and said second housing are dimensioned and configured to contain said sound reinforcement means and wherein said first housing and said second housing are dimensioned and configured to replace the air vent cover of the motorcycle.

20. The speaker assembly in claim 19 wherein said sound reinforcement means comprise a at least one audio speaker and wherein said first housing is located on the left side of the motorcycle and wherein said second housing is located on the right side of the motorcycle.
